(19) United States
(12) Patent Application Publication
(10) Pub. No.: US 2026/0357003 A1
(43) Pub. Date: Nov. 12, 2026

(54) NEW POLYURETHANE FOAM CATALYSTS HAVING IMPROVED STORAGE STABILITY

(71) Applicant: BASF SE, Ludwigshafen am Rhein (DE)

(72) Inventors: Radoslaw Kierat, Ludwigshafen am Rhein (DE); Michael Henningsen, Ludwigshafen am Rhein (DE); Julian Boehringer, Ludwigshafen am Rhein (DE)

(73) Assignee: BASF SE, Ludwigshafen am Rhein (DE)

(21) Appl. No.: 19/103,689

(22) PCT Filed: Aug. 14, 2023
(86) PCT No.: PCT/EP2023/072411

§ 371 Date: Feb. 13, 2025

(30) Foreign Application Priority Data
Aug. 16, 2022 (EP) 22190588.8

(51) Int. Cl. C08G 18/20; B01J 31/02; C08G 18/30; C08G 18/48; C08G 18/76; C08G 101/00; C08J 9/14

(52) U.S. Cl. CPC C08G 18/2027; C08G 18/302; C08G 18/4829; C08G 18/7664; C08J 9/144; B01J 31/0244; C08G 2101/00; C08G 2110/0025; C08G 2330/00; C08J 2203/162; C08J 2375/08

(57) ABSTRACT

A polyol mixture for spray foam applications has (a) from 10% to 99.7% by weight of at least one polyol as component A, (b) from 0.1% to 30% by weight of a hydrohaloolefin blowing agent as component B, (c) from 0.1% to 10% by weight of water as component C, (d) from 0.1% to 10% by weight of a catalyst as component D, and (e) optionally from 0% to 80% by weight of one or more further additives as one or more components E. Catalyst D includes an imidazolium salt of formula (I),

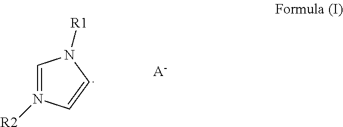

R1, R2 are aliphatic, cycloaliphatic, araliphatic or aromatic radicals having 1 to 20 carbon atoms, which may have one or more heteroatoms. A- is a carboxylate anion having 1 to 20 carbon atoms, which may also have one or more heteroatoms. The polyol mixture may be used in spray foam applications.

The invention relates to a polyol mixture comprising a polyol, a hydrohaloolefin blowing agent, water, and an imidazolium salt catalyst, to a process for producing rigid polyurethane foams, and to the use of the imidazolium salt as catalyst.

Rigid polyurethane foams have long been known and have been much described. Rigid polyurethane foams are used mainly for thermal insulation, for example in refrigeration units, means of transport or buildings, and also for the production of building elements, especially sandwich elements.

It is important that the rigid polyurethane foams fill the cavities evenly and without gaps, so that a stable structure that ensures good thermal insulation is created through the best possible connection with the outer layers. To prevent foam defects, the foamable PU reaction mixture must for this purpose be introduced into the cavity to be insulated within a short time. Low-pressure or preferably high-pressure machines are usually used for foaming of such objects.

A comprehensive review of the production of rigid polyurethane foams and their use as an outer layer or core layer in composite elements and also their deployment as an insulating layer in cooling or heating technology is found for example in “Polyurethane” [Polyurethanes], Kunststoff-Handbuch [Plastics Handbook], volume 7, 3rd edition 1993, edited by Dr Günter Oertel, Carl-Hanser-Verlag, Munich/Vienna.

Suitable rigid polyurethane foams can be produced in a known manner by reacting organic polyisocyanates with one or more compounds containing at least two reactive hydrogen atoms in the presence of blowing agents, catalysts, and optionally auxiliaries and/or additives.

Compounds having at least two hydrogen atoms reactive toward isocyanate groups used in the production of polyurethanes are preferably polyether alcohols and/or polyester alcohols. The choice of polyols is based in particular on cost and desired use properties (for example EP-A 1 632 511, U.S. Pat. No. 6,495,722, WO 2006/108833).

Polyurethane foam compositions are typically produced by reacting an isocyanate and a premix comprising isocyanate-reactive components such as polyols, preferably polyether alcohols and/or polyester alcohols. The premix optionally also comprises further components such as water, flame retardants, blowing agents, foam-stabilizing surfactants, and catalysts that promote the reaction of isocyanate with polyol resulting in urethane formation and also the reaction with water resulting in urea formation and the release of CO₂. The blowing agent in the premix is usually a liquid having a sufficiently low boiling point that is vaporized by the heat evolved during the polymerization reaction. Examples of blowing agents used in the production of insulating polyurethane foam include hydrofluorocarbons, hydrofluoroolefins, hydrofluorochloroolefins, hydrochlorofluorocarbons, formates, and hydrocarbons. For some uses, the premix is stored for up to a year before it is converted into polyurethane foam with isocyanate. This is common in spray foam applications in which drums of premix and of the isocyanate are supplied for use in situ. It is therefore desirable for the premix to be both chemically and physically stable. However, the catalysts that are suitable for promoting the polyurethane reaction may undergo or induce undesirable reactions with the blowing agents present in the premix, thereby reducing the storage stability of the premix. These undesirable reactions occur with blowing agents that comprise halogens and especially with unsaturated halogenated blowing agents. Customary amine catalysts suitable for producing polyurethane foam comprise tertiary amines such as N,N,N′,N″,N″-pentamethyldiethylenetriamine or 1,4-diazabicyclo[2.2.2]octane. The reaction between tertiary amine and halogen-containing organic compounds occurs with greater rapidity when the halogen atom is attached to an olefinic carbon, since halogen-substituted olefins are susceptible to nucleophilic attack by tertiary amines, which results in rapid deactivation of the tertiary amine catalysts.

EP 3 091 044 A1 discloses a polyol premix composition comprising a hydrohaloolefin blowing agent, at least one polyol, water, and a catalyst comprising at least 10% by weight of tetramethylguanidine and 10% to 90% by weight of one or more tertiary amines having an isocyanate-reactive group, selected from 2-[N-(dimethylaminoethoxyethyl)-N-methylamino]ethanol and N,N,N′-trimethyl-N′-3-aminopropylbis(aminoethyl) ether.

EP 2 504 372 A1 discloses a coating composition comprising
(A) at least one polyisocyanate obtainable by reacting at least one monomeric isocyanate,
(B) at least one compound having at least two isocyanate-reactive groups, a number-average molecular weight Mn of at least 1000 g/mol, and an OH value of 40 to 350 mg KOH/g,
(C) at least one imidazolium salt,
(D) optionally a solvent,
(E) optionally a further urethanization catalyst different from (C), and also
(F) optionally further typical coatings components and/or additives.

The object of the invention is to provide a polyurethane blowing catalyst that is storage-stable and is not deactivated in a polyol mixture comprising a hydrohaloolefin blowing agent.

The object is achieved by a polyol mixture comprising
a) at least one polyol as component A,
b) a hydrohaloolefin blowing agent as component B,
c) water as component C,
d) a catalyst as component D,
e) optionally one or more further additives as one or more further components E,
wherein catalyst D comprises an imidazolium salt of the general formula (I),

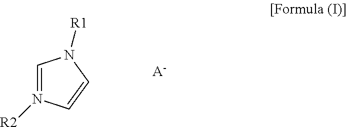

where R1, R2 are independently an aliphatic, cycloaliphatic, araliphatic or aromatic radical having 1 to 20 carbon atoms, which may in addition also comprise one or more heteroatoms, where A- is a carboxylate anion having 1 to 20 carbon atoms, which may in addition also comprise one or more further heteroatoms.

The heteroatoms may be selected from oxygen, nitrogen, sulfur, and phosphorus. For example, R1, R2 may comprise 1 to 5 heteroatoms and A-1 to 5 further heteroatoms.

The polyol mixture comprises as component A at least one polyol. In preferred embodiments, the polyol component comprises polyols typically used for producing rigid PIR/PUR (polyisocyanurate and/or polyurethane) foam. Such polyols include, but are not limited to, polyalkylene ethers and polyester polyols. In one embodiment, the polyalkylene ether comprises a poly(alkylene oxide) polymer, such as poly(ethylene oxide) and poly(propylene oxide) polymers and copolymers having terminal hydroxyl groups derived from polyhydric compounds, including diols and triols, for example inter alia ethylene glycol, propylene glycol, butane-1,3-diol, butane-1,4-diol, hexane-1,6-diol, neopentyl glycol, diethylene glycol, dipropylene glycol, pentaerythritol, glycerol, diglycerol, trimethylolpropane, cyclohexanediol, sugars such as sucrose and similar low-molecular-weight polyols or combinations thereof. In another embodiment, the polyol component comprises amine polyether polyols that can be produced when an amine, such as ethylenediamine, diethylenetriamine, tolylenediamine, diphenylmethanediamine, triethanolamine or the like, is reacted with ethylene oxide or propylene oxide. In one embodiment directed to a spray foam formulation, the polyol component comprises polyether polyols, as a result of which the reactivity of the polyurethane composition is enhanced.

In one embodiment, the polyether polyols are prepared by condensation of phenol with formaldehyde in the presence of hydroxyl-containing amines such as diethanolamine, ethanolamine, and the like.

The polyether polyols are prepared from one or more alkylene oxides having 2 to 4 carbon atoms in the alkylene radical by known processes, for example by anionic polymerization with alkali metal hydroxides, for example sodium or potassium hydroxide, or alkali metal alkoxides, for example sodium methoxide, sodium or potassium methoxide or potassium isopropoxide, as catalysts and with addition of at least one starter molecule comprising 2 to 8, preferably 2 to 6, attached reactive hydrogen atoms, or by cationic polymerization with Lewis acids, such as inter alia antimony pentachloride, boron fluoride etherate or fuller's earth as catalysts. Suitable polyether polyols can also be produced using DMC catalysts.

Examples of suitable alkylene oxides are tetrahydrofuran, 1,3-propylene oxide, 1,2- and 2,3-butylene oxide, styrene oxide, and preferably ethylene oxide and 1,2-propylene oxide. The alkylene oxides may be used individually, alternately in succession or as mixtures. Preferred alkylene oxides are propylene oxide and ethylene oxide; particular preference is given to propylene oxide.

Examples of useful starter molecules include: water, organic dicarboxylic acids such as succinic acid, adipic acid, phthalic acid and terephthalic acid, aliphatic and aromatic, optionally N-monoalkyl- and N,N- and N,N′-dialkyl-substituted diamines having 1 to 4 carbon atoms in the alkyl radical, such as optionally mono- and dialkyl-substituted ethylenediamine, diethylenetriamine, triethylenetetramine, propylene-1,3-diamine, butylene-1,3- or -1,4-diamine, hexamethylene-1,2-, -1,3-, -1,4-, -1,5-, and -1,6-diamine, phenylenediamines, tolylene-2,3-, -2,4-, and -2,6-diamine and 4,4′-, 2,4′-, and 2,2′-diaminodiphenylmethane.

Useful starter molecules further include: alkanolamines, for example ethanolamine, N-methyl- and N-ethylethanolamine, dialkanolamines, for example diethanolamine, N-methyl- and N-ethyldiethanolamine, and trialkanolamines, for example triethanolamine, and ammonia.

Preference is given to using di- or polyhydric alcohols, such as ethanediol, propane-1,2- and -1,3-diol, diethylene glycol, dipropylene glycol, butane-1,4-diol, hexane-1,6-diol, glycerol, trimethylolpropane, pentaerythritol, sorbitol, and sucrose. Particular preference is given to the abovementioned primary amines, for example tolylene-2,3-diamine.

The polyether polyols, preferably polyoxypropylene polyols and/or polyoxyethylene polyols, have a functionality of preferably 2 to 6 and especially 2 to 5 and number-average molecular weights of 150 to 3000, preferably 200 to 1500, and especially 250 to 750.

Suitable polyester polyols may be prepared for example from organic dicarboxylic acids having 2 to 12 carbon atoms, preferably aromatic dicarboxylic acids or a mixture of aromatic and aliphatic dicarboxylic acids, and polyhydric alcohols, preferably diols, having 2 to 12 carbon atoms, preferably 2 to 6 carbon atoms. Examples of useful dicarboxylic acids include: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids can be used here either individually or else in a mixture. Instead of the free dicarboxylic acids it is also possible to use the corresponding dicarboxylic acid derivatives, for example dicarboxylic esters of alcohols having 1 to 4 carbon atoms or dicarboxylic anhydrides. Aromatic dicarboxylic acids used are preferably phthalic acid, phthalic anhydride, terephthalic acid, and/or isophthalic acid in a mixture or on their own. Aliphatic dicarboxylic acids used are preferably dicarboxylic acid mixtures of succinic acid, glutaric acid, and adipic acid in quantitative proportions of, for example, 20 to 35:35 to 50:20 to 32 parts by weight, and especially adipic acid. Examples of di- and polyhydric alcohols, especially diols, are: ethanediol, diethylene glycol, propane-1,2-and-1,3-diol, dipropylene glycol, butane-1,4-diol, pentane-1,5-diol, hexane-1,6-diol, decane-1,10-diol, glycerol, trimethylolpropane, and pentaerythritol. Preference is given to using ethanediol, diethylene glycol, butane-1,4-diol, pentane-1,5-diol, hexane-1,6-diol or mixtures of at least two of the diols mentioned, especially mixtures of butane-1,4-diol, pentane-1,5-diol, and hexane-1,6-diol. It is also possible to use polyester polyols derived from lactones, for example ¿-caprolactone, or hydroxycarboxylic acids, for example w-hydroxycaproic acid.

For the preparation of the polyester polyols it is also possible to use biobased starter materials and/or derivatives thereof, for example castor oil, palm oil, polyhydroxy fatty acids, ricinoleic acid, hydroxy-modified oils, grapeseed oil, black cumin oil, pumpkin seed oil, borage seed oil, soybean oil, wheatgerm oil, rapeseed oil, sunflower seed oil, peanut oil, apricot kernel oil, pistachio nut oil, almond oil, olive oil, macadamia nut oil, avocado oil, sea buck thorn oil, sesame oil, hemp oil, hazelnut oil, evening primrose oil, wild rose oil, safflower oil, walnut oil, hydroxy-modified fatty acids and fatty acid esters based on myristoleic acid, palmitoleic acid, stearic acid, palmitic acid, oleic acid, vaccenic acid, petroselinic acid, gadoleic acid, erucic acid, nervonic acid, linoleic acid, α- and γ-linolenic acid, stearidonic acid, arachidonic acid, timnodonic acid, clupanodonic acid, and cervonic acid.

Preferred polyester polyols are prepared from adipic acid, phthalic anhydride and/or terephthalic anhydride as dicarboxylic acids and propylene glycol, dipropylene glycol, ethylene glycol, diethylene glycol, glycerol, and/or trimethylolpropane as alcohol component, and also oleic acid or castor oil and have an OH value of 150 to 400 and a functionality of 2 to 4.5.

The polyol mixture comprises as catalyst D an imidazolium salt of the general formula (I).

R1 and R2 in formula (I) are independently preferably an aliphatic, cycloaliphatic, araliphatic or aromatic organic radical having 1 to 10 carbon atoms. Examples of hydrocarbon radicals comprise the phenyl group, the benzyl group, phenyl or benzyl groups substituted with one or more C1-C4 alkyl groups, such as the mesityl group, and also alkyl groups and alkenyl groups, especially alkyl groups.

Preferably, R1 and R2 are independently a C1-C18 alkyl group, preferably a C1-C16 alkyl group, more preferably a C1-C14 alkyl group, further preferably a C1-C12 alkyl group, and especially preferably a C1-C10 alkyl group. Very particularly preferably, R1 and R2 are independently a C1-C6 alkyl group, especially a C1-C4 alkyl group. Especially preferably, R1 and R2 are independently selected from methyl, ethyl, n-propyl, isopropyl, n-butyl, sec-butyl or tert-butyl, of which methyl, ethyl, n-propyl, and n-butyl are particularly preferred.

Examples of imidazolium ions are 1,3-dimethylimidazolium (DMIM), 1-benzyl-3-methylimidazolium, 3-ethyl-1-methylimidazolium (EMIM), 1-propyl-3-methylimidazolium, 3-n-butyl-1-methylimidazolium, 1-hexyl-3-methylimidazolium, 1-methyl-3-octylimidazolium, 1-decyl-3-methylimidazolium, 1-dodecyl-3-methylimidazolium, 1,3-diethylimidazolium (DEIM), 1,3-diisopropylimidazolium, 1,3-di-n-butylimidazolium, and 1,3-dihexylimidazolium.

Preferred imidazolium ions are 1,3-dimethylimidazolium (DMIM), 3-ethyl-1-methylimidazolium (EMIM), and 1,3-diethylimidazolium (DEIM). Particular preference is given to 1,3-dimethylimidazolium (DMIM) and 1,3-diethylimidazolium (DEIM).

Carboxylate anions A- in formula (I) may be anions of aliphatic or aromatic carboxylic acids having 1 to 20 carbon atoms, preferably anions of aliphatic carboxylic acids having 1 to 20 carbon atoms.

Examples of anions of aromatic carboxylic acids are benzoate, salicylate, and nicotinate. Alkanoate anions, i.e. the anions of an alkanecarboxylic acid, may be straight-chain or branched, preferably straight-chain. The parent alkanecarboxylic acid has 1 to 20 carbon atoms, preferably 2 to 18, and more preferably 2 to 12 carbon atoms.

Examples of alkanoate anions are formate, acetate, propionate, 2,2-dimethylpropionate (pivalate), n-butanoate, isobutanoate, n-pentanoate, n-hexanoate, n-heptanoate, n-octanoate, 2-ethylhexanoate, isooctanoate, n-nonanoate, isononanoate, n-decanoate, 3-propylheptanoate, n-dodecanoate, tetradecanoate, hexadecanoate, stearates, and n-eicosanoate, preference being given to acetate, formate, propionate, n-butanoate, isobutanoate, n-pentanoate, 2,2-dimethylpropionate (pivalate), and n-hexanoate, and particular preference to acetate, formate, and propionate, with acetate especially preferred.

The catalysts used according to the invention are suitable for producing rigid insulating foam and are particularly suitable for spray foam applications, device insulation, insulating building panels, and other insulation products comprising closed-cell rigid polyurethane foam. The invention comprises foams having an isocyanate index between 70 and 500, 90 to 270, and typically 100 to 150. The catalysts used according to the invention could be used in combination with any halogenated blowing agent in order to provide improved system stability and are especially suitable for improving the stability of systems comprising hydrohaloolefin blowing agents, especially HFCO-1234ze (trans-1,3,3,3-tetrafluoroprop-1-ene) and HFCO-1233zd (1-chloro-3,3,3-trifluoro-1-propene).

As one or more additives E, the polyol mixture may comprise cell stabilizers, chain extenders, pigments, fillers, organic acids or diacids, flame retardants, additional urethane gelation catalysts, additional urethane foam catalysts, transition metal catalysts or combinations thereof.

Suitable cell stabilizers comprise silicone surfactants, anionic surfactants, cationic surfactants, zwitterionic surfactants, nonionic surfactants, and combinations thereof. In one embodiment, the cell stabilizer is a silicone surfactant, such as polyalkylsiloxane, polyoxyalkylene polyol-modified dimethylpolysiloxane or alkylene glycol-modified dimethylpolysiloxane. In another embodiment, the cell stabilizer is an anionic surfactant, such as the salt of a fatty acid, the salt of a sulfuric ester, the salt of a phosphoric ester, the salt of a sulfonic acid, or combinations thereof. Suitable cationic surfactants are quaternary ammonium salts (pH-dependent or permanently charged) such as cetyltrimethylammonium chloride, cetylpyridinium chloride, polyethoxylated tallow amine, benzalkonium chloride, benzethonium chloride, and the like. Suitable zwitterionic or amphoteric surfactants comprise sultaines, amino acids, imino acids, betaines, and phosphates. Suitable nonionic surfactants comprise fatty alcohols, polyoxyethylene glycol alkyl ethers, polyoxypropylene glycol alkyl ethers, glucosides (such as decyl, lauryl, and octyl glucosides), polyoxyethylene glycol alkyl phenol ethers, glycol alkyl esters, and the like. The polyol mixture may comprise cell stabilizers for example in amounts of 0.1% to 20% by weight.

Suitable pigments are organic pigments, inorganic pigments or combinations thereof. In certain embodiments in which the pigment is an organic pigment, the pigment is an azo/diazo dye, a phthalocyanine, dioxazine, carbon black, or a combination thereof. In other embodiments, in which the pigment is an inorganic pigment, the pigment is titanium dioxide, iron oxide, chromium oxide, or a combination thereof. The polyol mixture may comprise pigments for example in amounts of 0.1% to 10% by weight.

Suitable fillers increase the density and load-bearing capacity of the polyurethane foams. In certain embodiments, the filler is barium sulfate, calcium carbonate or a combination thereof. The polyol mixture may comprise fillers for example in amounts of 0.1% to 20% by weight.

Suitable flame retardants include for example chlorinated phosphate esters, phosphate esters, chlorinated paraffin, melamine powder or combinations thereof. The polyol mixture may comprise flame retardants for example in amounts of 0.1% to 30% by weight.

The polyol mixture generally comprises
a) from 10% to 99.7% by weight, preferably from 35% to 97% by weight, of at least one polyol as component A,
b) from 0.1% to 30% by weight, preferably from 1% to 15% by weight, of a hydrohaloolefin blowing agent as component B,
c) from 0.1% to 10% by weight, preferably from 0.5% to 5% by weight, of water as component C,
d) from 0.1% to 10% by weight, preferably from 0.5% to 5% by weight, of the imidazolium salt catalyst of the general formula (I) as component D,
e) optionally from 0% to 80% by weight, preferably from 1% to 40% by weight, of one or more further additives as one or more components E.

The invention further relates to a process for producing rigid polyurethane foams by reacting
(i) organic or modified organic polyisocyanates with
(ii) the polyol mixture of the invention.

Useful organic polyisocyanates (i) are the aliphatic, cycloaliphatic, araliphatic, and preferably aromatic polyfunctional isocyanates that are known per se. The organic polyisocyanates may optionally be modified.

Specific examples include: alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (IPDI), hexahydrotolylene 2,4- and 2,6-diisocyanate and also the corresponding isomer mixtures, dicyclohexylmethane 4,4′-, 2,2′-, and 2,4′-diisocyanate and also the corresponding isomer mixtures, and preferably aromatic di- and polyisocyanates, for example tolylene 2,4- and 2,6-diisocyanate and the corresponding isomer mixtures, diphenylmethane 4,4′-, 2,4′-, and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 2,4′-, 2,4′-, and 2,2′-diisocyanates and polyphenylpolymethylene polyisocyanates (crude MDI), and mixtures of crude MDI and tolylene diisocyanates. The organic diisocyanates and polyisocyanates may be used individually or in the form of mixtures thereof.

Preferred polyisocyanates are tolylene diisocyanate (TDI), diphenylmethane diisocyanate (MDI), and especially mixtures of diphenylmethane diisocyanate and polyphenylenepolymethylene polyisocyanates (polymeric MDI or PMDI).

Use is commonly also made of modified polyfunctional isocyanates, i.e. products obtained by chemical reaction of organic polyisocyanates. Examples include polyisocyanates comprising ester, urea, biuret, allophanate, carbodiimide, isocyanurate, uretdione, carbamate and/or urethane groups.

For production of the rigid polyurethane foams of the invention, very particular preference is given to using polymeric MDI.

The invention also relates to the use of an imidazolium salt of the general formula (I) as a catalyst for producing rigid polyurethane foams in a polyol mixture comprising a hydrohaloolefin blowing agent.

The invention is elucidated more particularly by the examples that follow.

### EXAMPLES

### Components Used:

Lupranol 3300: Polyether triol having an OH value of 400 mg KOH/g Foam stabilizer: Silicone-based
Blowing agent: R-1233zd (E)=1-chloro-3,3,3-trifluoro-1-propene
Lupranat M20S: Polymeric MDI, NCO 31.5%, viscosity 210 mPa·s

### Method 1

A polyol mixture is prepared by mixing 100 g of Lupranol 3300, 4 g of water, and 2 g of foam stabilizer. 15 g of this mixture plus an additional 1% by weight of catalyst is mixed with 17.1 g of Lupranat M20S in a 0.5 L plastic beaker for 5 seconds with a propeller stirrer at 2000 rpm and measured.

The following parameters were determined:
Cream time: Time until the PU mixture begins to rise;
Half height: Time until reaching beaker half height (7 cm);
Time until reaching the edge of the beaker;
Time until foaming has ended;
Foam height.

The results are shown in table 1.

### Method 2

For this, a stock solution composed of Lupranol 3300, foam stabilizer, and water was prepared. Per container, 52 g of this stock solution, comprising 50 g of Lupranol 3300, 1 g of foam stabilizer, and 1 g of water, was weighed into a pressure-resistant 500 mL laboratory glass bottle, then 1 g of catalyst and 7.5 g of blowing agent R-1233zd (E) were added. The containers were stored at 45 °C for periods of 2 and 4 weeks. From each bottle, 17 g of the polyol mixture was mixed with 17.1 g of Lupranat M20S in a 0.5 L plastic beaker for 5 seconds with a propeller stirrer at 2000 rpm and measured.

The following parameters were determined:
Cream time: Time until the PU mixture begins to rise;
Half height: Time until reaching beaker half height (7 cm);
Time until reaching the edge of the beaker;
Time until foaming has ended;
Foam height.

The results are shown in table 2.

As can be seen in table 2, BDMAEE shows inadequate storage stability in the presence of R-1233zd (E).

DMI is not entirely harmless from a toxicological viewpoint (skin sensitizing).

TABLE 1
Method 1

| | | | | | Time | | | |
|---|---|---|---|---|---|---|---|---|
| | | | | | until | | | |
| | | | | | reaching | Time | | |
| | | | | | the | until | | |
| | | | | Half | edge | foaming | | |
| Ex- | | | Cream | height | of the | has | Foam | |
| amples | Catalyst | Name | time | (7 cm) | beaker | ended | height | |
| C1 | | DMI-1,2- | 21 s | 63 s | 82 s | 163 s | 18.7 | cm |
| | | dimethyl- | | | | | | |
| | | imidazole | | | | | | |
| 1 | 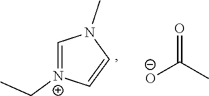 | EMIM acetate | 22 s | 62 s | 81 s | 212 s | 20.1 | cm |
| 2 | 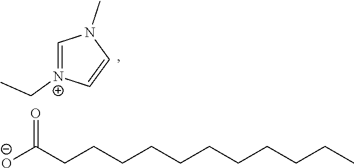 | EMIM dodecanoate | 29 s | 117 s | 164 s | 365 s | 19.0 | cm |
| 3 | 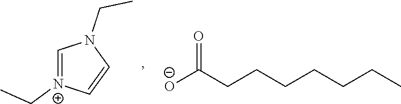 | DEIM octanoate | 31 s | 102 s | 142 s | 318 s | 18.8 | cm |
| 4 | 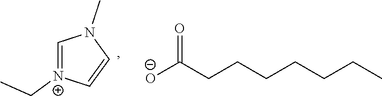 | EMIM octanoate | 32 s | 105 s | 146 s | 312 s | 19 | cm |
| 5 | 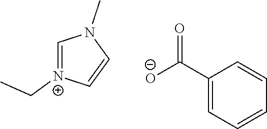 | EMIM benzoate | 29 s | 108 s | 169 s | 389 s | 18.9 | cm |
| C2 | 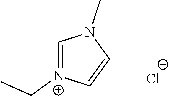 | Basionics ST80 | 110 s | 332 s | — | >840 s | 14 | cm |
| C3 | 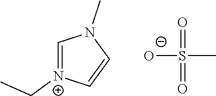 | Basionics ST 35 | 92 s | 309 s | 865 s | >840 s | 14.0 | cm |
| C4 | EMIM diethylphosphate | EMIM | 46 s | 251 s | 707 s | 758 s | 14.0 | cm |
| | | diethyl- | | | | | | |
| | | phosphate | | | | | | |
| C5 | 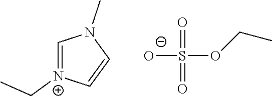 | Basionics LQ01 | 96 s | 327 s | 832 s | >840 s | 14 | cm |

EMIM = 1,3-ethylmethylimidazolium
DEIM = 1,3-diethylimidazolium

TABLE 2
Method 2

| | | | | | | | | Time until | | | | | |
|---|---|---|---|---|---|---|---|---|---|---|---|---|---|
| | Addition | | Storage | | | Half | | reaching the | | Time until | | | |
| | of blowing | | time in | | | height | | edge of the | | foaming has | | | |
| Examples | agent | Catalyst | weeks | Cream time | | (7 cm) | | beaker | | ended | | Foam height | |
| 6 | yes | DEIM acetate | 0 | 13 | s | 40 | s | 62 | s | 147 | s | 21.8 | cm |
| 6 | yes | DEIM acetate | 2 | 13 | s | 43 | s | 66 | s | 150 | s | 21.0 | cm |
| 6 | yes | DEIM acetate | 4 | 14 | s | 42 | s | 63 | s | 148 | s | 21.2 | cm |
| 7 | yes | DMIM acetate | 0 | 15 | s | 41 | s | 63 | s | 145 | s | 21.6 | cm |
| 7 | yes | DMIM acetate | 2 | 15 | s | 40 | s | 60 | s | 143 | s | 21.5 | cm |
| 7 | yes | DMIM acetate | 4 | 16 | s | 42 | s | 63 | s | 146 | s | 21.5 | cm |
| C1 | yes | DMI | 0 | 24 | s | 59 | s | 77 | s | 132 | s | 20 | cm |
| C1 | yes | DMI | 2 | 23 | s | 58 | s | 76 | s | 133 | s | 20.5 | cm |
| C1 | yes | DMI | 4 | 23 | s | 57 | s | 76 | s | 135 | s | 20.7 | cm |
| C6 | yes | BDMAEE | 0 | 5 | s | 10 | s | 18 | s | 70 | s | 21.5 | cm |
| C6 | yes | BDMAEE | 2 | 7 | s | 17 | s | 35 | s | 98 | s | 20.5 | cm |
| C6 | yes | BDMAEE | 4 | 8 | s | 36 | s | 73 | s | 162 | s | 19.0 | cm |
| 8 | yes | EMIM acetate | 0 | 13 | s | 40 | s | 60 | s | 146 | s | 21.8 | cm |
| 8 | yes | EMIM acetate | 2 | 13 | s | 42 | s | 62 | s | 149 | s | 21.3 | cm |
| 8 | yes | EMIM acetate | 4 | 13 | s | 41 | s | 63 | s | 150 | s | 21.1 | cm |
| 9 | yes | EMIM octano-ate | 0 | 17 | s | 56 | s | 84 | s | 183 | s | 21.3 | cm |
| 9 | yes | EMIM octano-ate | 2 | 18 | s | 58 | s | 86 | s | 182 | s | 21.0 | cm |
| 9 | yes | EMIM octano-ate | 1 | 18 | s | 59 | s | 86 | s | 183 | s | 20.3 | cm |

DEIM = 1,3-diethylimidazolium
DMIM = 1,3-dimethylimidazolium

1-18. (canceled)

19: A process for producing a rigid polyurethane foam having an isocyanate index of 100 to 150 for spray foam applications, the process comprising
reacting (i) organic or modified organic polyisocyanates with (ii) a polyol mixture, the polyol mixture comprising:
a) from 10% to 99.7% by weight of at least one polyol as component A,
b) from 0.1% to 30% by weight of a hydrohaloolefin blowing agent comprising trans-1-chloro-3,3,3-trifluoropropene as component B,
c) from 0.1% to 10% by weight of water as component C,
d) from 0.1% to 10% by weight of a catalyst as component D,
e) optionally from 0% to 80% by weight of one or more further additives as one or more further components E,
wherein catalyst D comprises an imidazolium salt of the general formula (I), 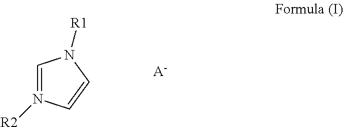
where R1, R2 are each independently an aliphatic, cycloaliphatic, araliphatic or aromatic radical having 1 to 20 carbon atoms, optionally comprising one or more heteroatoms,
where A- is a carboxylate anion having 1 to 20 carbon atoms, optionally comprising one or more further heteroatoms,
for spray foam applications.

20: The process according to claim 19, wherein R1 and R2 in the general formula (I) are each methyl or ethyl.

21: The process according to claim 19, wherein the carboxylate anion A- is selected from the group consisting of formate, acetate, propionate, 2,2-dimethylpropionate (pivalate), n-butanoate, isobutanoate, n-pentanoate, n-hexanoate, n-heptanoate, n-octanoate, 2-ethylhexanoate, isooctanoate, n-nonanoate, isononanoate, n-decanoate, 3-propylheptanoate, n-dodecanoate, tetradecanoate, hexadecanoate, stearates, and n-eicosanoate.

22: The process according to claim 19, wherein the carboxylate anion A- is acetate.

23: The process according to claim 19, wherein the polyol A comprises a polyether polyol and optionally a polyester polyol.

24: The process according to claim 19, wherein the one or more further additives E are present and are selected from the group consisting of cell stabilizers, chain extenders, pigments, fillers, organic acids, organic diacids, flame retardants, additional urethane gelation catalysts, additional urethane foam catalysts, transition metal catalysts, and combinations thereof.

25: The process according to claim 19, wherein the rigid polyurethane foam is a rigid insulating foam.

26: The process according to claim 25, wherein the rigid insulating foam is configured for device insulation.
